(19) United States
(12) Patent Application Publication
(10) Pub. No.: US 2001/0012044 A1
(43) Pub. Date: Aug. 9, 2001

(54) Thermal printer with bi-directional print head movement and method thereof

(76) Inventor: Samuel Reele, Rochester, NY (US)

Correspondence Address: Milton S. Sales, Eastman Kodak Company, Patent Legal Staff, 343 State Street, Rochester, NY, 14650-2201, US

(21) Appl. No.: 09/766,077

(22) Filed: Jan. 19, 2001

Related U.S. Application Data
(63) Continuation of application No. 09/314,387, filed on May 19, 1999, now abandoned.

(51) Int. Cl. B41J 2/325

(52) U.S. Cl. 347/174; 347/176

(57) ABSTRACT

Thermal printer with bi-directional print head movement and method thereof. The invention comprises a more time efficient thermal printing mechanism (100) including an assembly of one thermal print head (111) or a first thermal print head (11a) and a second thermal print head (11b). Either of the print heads being adapted with at least one universal bi-directional stepping motor (121) controlling the movement of the thermal printing head (111) or one universal bi-directional stepping motor (222) controlling the movement of the first thermal printing head (11a) and the second thermal printing head (11b). The invention also comprises a method of generating a hard copy (113) comprising only one ejection step from either the thermal printing mechanism (100) using one print head (111) or the thermal printing mechanism (200) using the first thermal printing head (11a) and the second thermal printing head (11b). The thermal printing mechanism (100) and the thermal printing mechanism (200) each uses a line by line sequential printer row of elements (113a) or dual rows of elements (312a) and (312b). The thermal printing mechanism (100) with one printing head (111) operates bilaterally in relation to the flow direction of the thermal printing medium (314). Alternatively, the thermal printing mechanism (200) simultaneously operates dual thermal printing heads (11a) and (11b) bilaterally with one universal stepping motor (222) operating bi-directionally with only one ejection for release of a thermally sensitive hard copy output media (413). The printing head (111) is adapted to print using a single source of donor material (116). A pair of print heads (11a) and (11b) are adapted to use a single source (316) of donor material with the source (316) providing color media sections (315) and (318) such as yellow and magenta. Another pair of print heads (411a) and (411b) are adapted to use a plurality of output spools (416a) and (416b) of donor material with each of the donor media output spools (416a) and (416b) providing a different color such as yellow and magenta, respectively, or cyan and black, respectively.

### FIELD OF THE INVENTION

The present novel invention relates generally to a thermal printer adapted to more efficiently print a thermal hard copy output resulting in less time to produce a thermal print. More specifically, the present invention relates to a thermal printing mechanism and method of utilizing a bilateral single head printer or multiple heads for printing alternate or multiple rows simultaneously in multiple colors.

### BACKGROUND OF THE INVENTION

Technology related to the novel invention is disclosed in Japan Patent No. 8,072,282 assigned to Fuji. Also, U.S. Pat. No. 5,367,321 assigned to Kyocera, discloses an electrical circuit system comparable to that used in the novel improved invention. The problem of improving print speed in related printers is addressed in both Japan Patent No. 6,127,267 assigned to Sharp and U.S. Pat. No. 4,774,529 assigned to Xerox. Of further background relevance are Japan Patent No. 7,214,870 assigned to Brother Kogyo; U.S. Pat. No. 5,196,864 assigned to Eastman Kodak; and, Japan Patent No. 7,184,410 assigned to Silver Seiko.

More relevant is Japan Patent No. 8,072,282 which discloses the use of three staggered print heads arranged linearly to improve print speed and Japan Patent No. 6,127,267 wherein two parallel electrodes provide simultaneous recording. Japan Patent No. 7,214,870 also discloses an arrangement wherein one or more print heads are arranged in parallel.

For additional background purposes, U.S. Pat. No. 5,367,321 issued to Shigenori, et al. discloses multiple insulating substrates to form a linear heating element in a thermal printer and U.S. Pat. No. 4,774,529 suggests a printing system for increasing the speed of a multi-color printer when utilized in a single color mode by repositioning the recording head cartridge from a first level to a second level to enable two lines of information to be created during a single scanning pass when it has been determined by the electronic means to be of the same color.

Other art appears in U.S. Pat. No. 5,196,864 wherein a multiple print head thermal printer is disclosed.

U.S. Pat. No. 4,946,297; U.S. Pat. No. 5,000,595; and, Japan Patent No. 7,184,410 refer to the use of four separate line print heads being mounted and teaches how to split a line into four prints using four separate print heads and then joining the line together.

Today's thermal printers are designed with one thermal head and multiple donor media types. Typically, the donor media is composed of multiple areas of different donor material which are mechanically linked in a specific sequential order. Typically, three areas of color specific donor material are required for a photographic quality thermal hard copy print. For a typical donor today, that sequence of color specific donor material may be yellow, magenta, and cyan. Other donor materials may be composed of a base sequence of four color specific donor areas: yellow, magenta, cyan, and black. The particular sequence of donor material (whatever that may be) is repeated in a serial fashion to complete a roll of donor material.

Referring to prior art, FIG. 1, in producing a thermal hard copy output, donor material (usually the least thermally active color, yellow 15) is positioned over the thermal paper 13. Mechanical rollers 16 and 17, edge and color sensors are used to recognize and position the desired donor material color over the thermal output paper. A thermal head 11, in which pixels 12 (typically 300 per inch) are arranged in a linear fashion, is positioned at the edge of the thermal paper. Digitized control data is then applied to each pixel simultaneously (usually pulse modulated) such that a row or line of one color is printed onto the thermal paper. Through stepper motors and mechanics, and control logic, for example, such as disclosed by the electrical circuit system in Kyocera which is adopted and incorporated herein by reference, either the thermal print head or thermal output paper is advanced one line or row and the thermal transfer process is repeated for that row. This whole sequence is repeated until one color is thermally transferred onto one full sheet of desired thermal output paper. The thermal paper is projected, as shown in prior art FIG. 1b, donor material is advanced to the next color area, and the thermal output paper is re-inserted, as shown in prior art FIG. 1c. The entire process is repeated until the next color (for example, magenta 18) in the sequence is transferred onto the thermal output paper. This process is repeated again with donor material advancing to the next color area until all colors of the donor material are transferred or thermally printed onto the thermal output paper. The problem with this process is that it requires a relatively lengthy time period to complete. More particularly, it is time-consuming, mechanically intensive and requires four paper projections for a donor composed of four independent color areas per each thermal print.

The novel invention resolves the problem of lengthy time consumption and four paper projections for a donor composed of three independent color areas for each thermal print. Specifically, the novel invention significantly reduces the required projections and mechanical steps, and thereby the printing time necessary for a thermal printer to produce a thermal print.

### SUMMARY OF THE INVENTION

An object of this invention is to provide a novel combination of steps in a thermal printer printing process wherein the output paper is retained and thermal printing occurs in a bilateral direction instead of a unilateral direction and wherein the output paper is ejected after the application of each color.

This object is achieved by a novel integration of a preferred embodiment thermal printer mechanism having a donor media which contains a yellow media section, a magenta media section, a cyan media section, and a black media section, all of which are positioned mechanically between the thermal print head and the thermal output media by the rotation of two roller spools. In addition, the thermal print head contains a mounting mechanism that works like a universal socket wherein the thermal head is precisely positioned over the donor media at the correct angle when the head is traveling in a left to right motion as well as a right to left motion. The stepper motor control is adapted to direct a bi-directional stepper motor and comprises the electronics therefor.

One of the most outstanding advantages of the present invention is that the use of the above described mechanical and electrical combination significantly increases the printing speed of thermal head printers approximately 30% or more.

### BRIEF DESCRIPTION OF THE DRAWINGS

FIG. 1a is a perspective view of a first aspect of an internal printing mechanism in a prior art printer;

FIG. 1b is a perspective view of a second aspect of the internal printing mechanism in the prior art printer;

FIG. 1c is a perspective view of a third aspect of the printing mechanism in the prior art printer;

FIG. 2a is a perspective view of a first aspect of an internal printing mechanism which depicts a first preferred embodiment of a printing mechanism of the novel invention;

FIG. 2b is a perspective view of a second aspect of the internal printing mechanism which depicts the first preferred embodiment of the printing mechanism of the novel invention;

FIG. 2c is a perspective view of a third aspect of the internal printing mechanism which depicts a first preferred embodiment of the printing mechanism of the novel invention;

FIG. 2d is a perspective view of a fourth aspect of the internal printing mechanism which depicts the first preferred embodiment of the printing mechanism of the novel invention;

FIG. 2e is a perspective view of a fifth aspect of the internal printing mechanism which depicts the first preferred embodiment of the printing mechanism of the novel invention;

FIG. 2f is a perspective view of a sixth aspect of the internal printing mechanism which depicts the first preferred embodiment of the printing mechanism of the novel invention;

FIG. 3 depicts a first alternative embodiment wherein separate multiple thermal heads and a single donor media spool are utilized for printing; and,

FIG. 4 depicts a second alternative embodiment wherein juxtaposed multiple thermal heads and multiple donor media spools are utilized for printing.

### DETAILED DESCRIPTION OF THE INVENTION

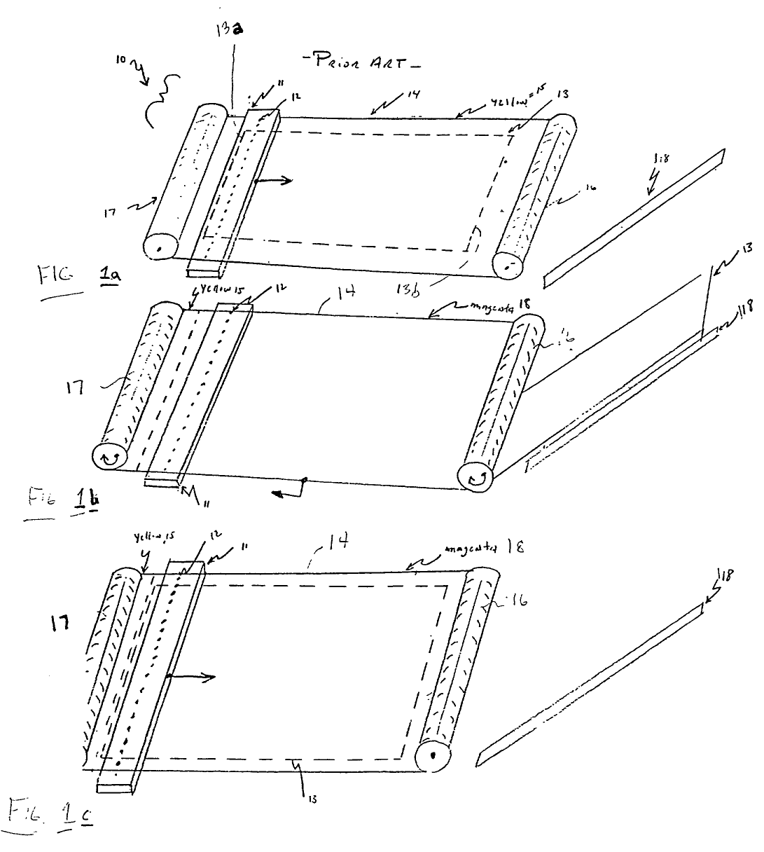

In IG. 1a there is shown a printer mechanism 10 of a prior art printer and an illustration of the prior art method of operation. As further shown in greater detail in FIGS. 1a, 1b, and 1c, these prior art thermal printers were designed to produce hard copy output 13 starting at a leading edge 13a and printing to a trailing edge 13b with one thermal head 11, thermal heating elements (or pixels) 12, and multiple donor media 14.

Typically the donor media 14 of the prior art as illustrated in FIGS. 1a, 1b, and 1c are composed of multiple areas of the donor media 14 which are mechanically linked in a specific sequential order. There is shown a yellow donor media 15 located in between a first donor media spool 16 and a second donor media spool 17. There also is a magenta donor media 18. As illustrated in FIGS. 1a and 1b, in the prior art at least two areas of color specific donor media 14 are required for a photographic quality thermal hard copy print. For typical donor media 14 today, that sequence of color specific donor material is yellow, magenta, and cyan. Other donor materials may be composed of a base sequence of four color specific donor areas: yellow, magenta, cyan, and black. The particular sequence of donor material (whatever that may be) is repeated in a serial fashion to make up a complete roll or spool of donor material.

In producing the thermal hard copy output 13 , donor material (usually the least thermally active color) is first positioned over the hard copy output 13, e.g. thermal paper. Mechanical rollers, edge and color sensors are used to recognize and position the desired donor material color over the thermal output paper. A thermal head, in which pixels (typically 300 per inch) are arranged in a linear fashion, is positioned at the edge of the thermal paper. Digitized control data is then applied to each pixel simultaneously (usually pulse modulated) such that a row or line of one color is printed onto the thermal paper. Using stepper motors and mechanics, and control logic well known in the art, either the thermal print head 11 or the hard copy output 13 or thermal paper is advanced one line or row and then the thermal transfer process is repeated for that line or row. This whole well known sequence is repeated until one color is thermally transferred onto one full sheet of desired hard copy output 13. The thermal paper is projected, donor material is advanced to the next color area, magenta 18, as shown in FIG. 1b. The hard copy output 13 or thermal output paper as shown in FIG. 1b is re-inserted and the magenta color is printed as shown in FIG. 1c. The entire process is repeated until the next color in the sequence is transferred onto the thermal output paper. As shown in FIG. 1b and 1c, this well known prior art process is repeated again with donor material advancing to the next color area of a plurality of color areas issuing from the first donor media spool 16 to the second donor media spool until all colors of the donor media 14 are transferred or thermally printed onto the hard copy output 13 or thermal output paper.

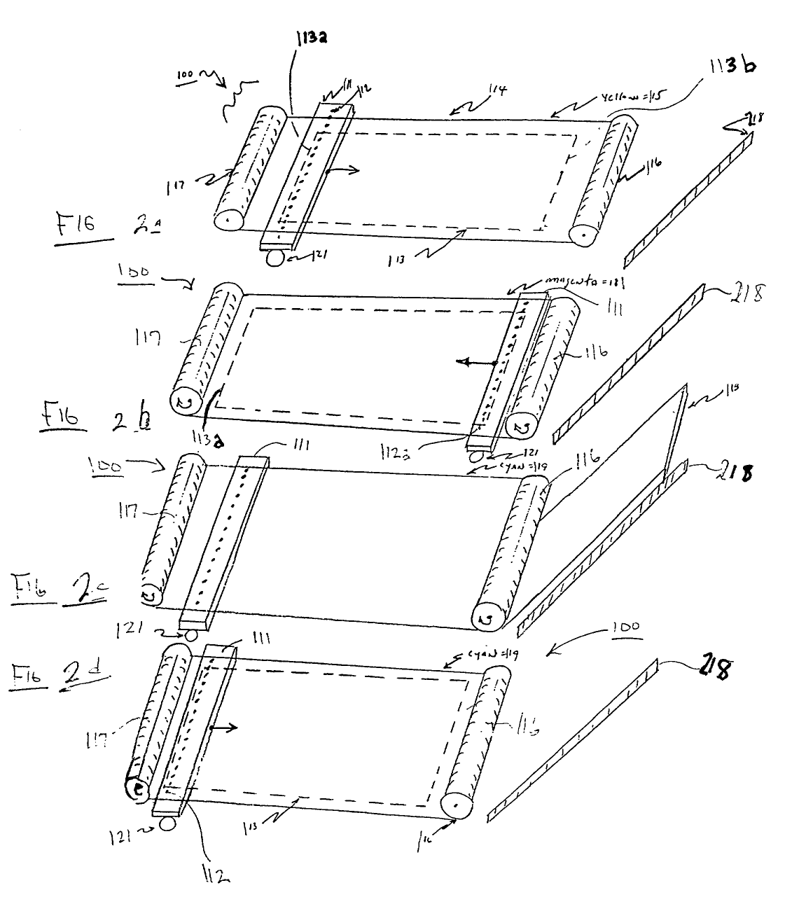

The above described prior art process as generally illustrated in FIGS. 1a, 1b, and 1c is characterized by engineers in the art as mechanically intensive because this prior art process requires no less than four (4) paper projections for a donor composed of a like number or three (3) independent color areas for each full color thermal print (typically a clear coat is printed over all colors). The resulting prior art process, as briefly shown in FIGS. 1a, 1b, and 1c, is a thermal process requiring an extended period of time, To. The novel invention as illustrated in FIGS. 2a, 2b, 2c, 2d, 2e, 2f and FIGS. 3 and 4 significantly reduces the processing time T₀ by approximately 20% to 50% to a new processing time T_{N}. Thereby, with the novel arrangement of donor elements and printing heads illustrated in FIGS. 2a through 4, printing time for a thermal printer is significantly and substantially reduced such that T₀−(0.20)T₀=T_{N}.

Referring again to FIG. 1a, a detailed description of the prior art printing process is as follows. The prior art printing mechanism 10 contains a thermal head 11 which contains thermal heating pixels. There are 300-440 elements 12 or pixels per inch in density, for example. The mechanism 10 also contains a thermally active donor material 14 which is mechanically positioned between the thermal head 11 and the hard copy output media 13, for example thermal paper. A specific color from the donor material 14 is provided by advancing (virgin) donor material 14 of various colors such as yellow 15 via two spools 16 and 17, respectively. When completed, the hard copy output media 13 or thermal paper is ejected from the printing mechanism 10 housed internally in a printer housing (not shown for clarity) and positioned onto a customer retrieval shelf 118.

As previously described, the prior art sequence and method of printing is depicted in FIGS. 1a, 1b, and 1c. Specifically, in FIG. 1a, the thermal head 11 commences a first step of printing by transferring yellow donor media 15 at the leading edge 13a opposite from the trailing edge 13b associated with the hard copy output 13. Via a single linear array of the individual elements 12, pulse width modulation commands, the thermally active donor material 14 is preferentially heated on a pixel by pixel basis for the entire line or row. Typically, the head 11 moves in a left to right motion or from the leading edge 13a to the trailing edge 13b of the thermal paper in a controlled fashion, transferring electronically selected colors from the donor material 14 from a raster or bit map function for the next line or row of the hard copy output 13. In the first step of this sequence all the appropriate yellow thermal media 15 is transferred to the entire area of the thermal hard copy output 13.

Shown in FIG. 1b, the thermal output 13 is temporarily ejected to the customer retrieval shelf 118. While this ejection step occurs, in a second step the thermal head 11 is repositioned to a position where the leading edge 13a of the thermal hard copy output media 13 was initially located.

As shown in FIG. 1c, the (virgin) donor media 14 is advanced by the step of simultaneously rotating the spools 16 and 17 in a like direction, respectively, such that the next color to be printed, for example donor media magenta 18, is in a position between the thermal head 11 and the thermal output 13.

It should be noted that notwithstanding whether the exact sequence of the above described prior art steps is utilized, the inventor has discovered that a common element in the prior art sequencing is that the thermal output paper or more specifically the thermal output 13 is always ejected at an intermediate step in the sequencing of the prior art printing process as illustrated in FIGS. 1a, 1b, and 1c.

In addition, the improvement represented in the novel invention is based partly on recognition of a unique attribute of the prior art, namely, that prior art thermal printing occurs in a unilateral direction. See, for example, FIGS. 1a, 1b and 1c. First, there is shown the yellow donor media 15. It is printed from left to right. Next, the paper is ejected, the thermal head 11 is moved in the z direction, the donor media is advanced to magenta 18, the thermal head 11 is lowered, and finally, the magenta 18 is printed from left to right where required by raster or bit mapping functions on a pixel by pixel or thermal element basis one row at a time until the entire output 13 has been thermally printed. In FIG. 1b the thermal output 13 is shown temporarily ejected and in FIG. 1c the color specific printing process repeats itself again.

A first preferred embodiment for the mechanism and steps of the novel invention are depicted in FIGS. 2a through 2f. There is shown an arrangement which utilizes a preferred embodiment thermal printing mechanism 100. The preferred embodiment thermal printing mechanism 100 contains a thermal head 111 with elements 112. It also contains a thermally sensitive output media 113 having a leading edge 113a, a trailing edge 113b, and a customer retrieval shelf 218. In addition, the preferred embodiment thermal printer mechanism contains donor media 114 which further contains a yellow media section 115 located between a first donor media spool 116 and a second donor media spool 117. There is also a magenta media section 181, a cyan media section 119, and a black media section 120. All of said media sections are adapted for positioning mechanically between the thermal print head 111 and the thermally sensitive output media 113 by the likewise rotation of the first donor media spool 116 and the second donor media spool 117. In addition, the thermal print head 111 contains a mounting mechanism, i.e., a universal stepping motor 121. With the universal stepping motor 121 connected to the thermal print head 111 it is precisely mechanically positioned over the donor media 114 at electronically pre-selected time intervals and at an electronically pre-selected angle as the print head 111 is traveling in a left to right direction and also when the thermal print head 111 is traveling intermittently in an opposite or right to left direction. Thus, a customary stepper motor control for the universal stepping motor 121 is altered and adapted using known and available mechanical means to operate the thermal print head 111 bi-directionally.

A novel sequence of operation for the preferred embodiment of thermal printer mechanism 100 is fully illustrated in FIGS. 2a, 2 b, 2c, 2d, 2e, and 2f. In FIG. 2a, the yellow media section 115 is positioned between the thermal head 111 and the output media 113 via the rotation of spools 116 and 117. The thermal head 111 is positioned intermittently at pre-selected heights and angles by the universal stepper motor 121. The novel mechanism and thermal printing process initially operates and progresses, respectively, as in the prior art initial sequencing up to the completion of printing all of the yellow color 115 to the thermal output paper edge 113b. In the novel printer mechanism 100 and in the method of its operation, instead of temporarily projecting the thermal output 113 onto the customer retrieval shelf 218 (as previously illustrated in FIG. 1b), the donor media 114 is advanced as shown in FIG. 2b until a magenta media section 181 is positioned over the thermal output media 113 via likewise rotation of the rollers 116 and 117 by employing the use of well known color donor sensors (not shown) and well-known motor control techniques. The thermal head 111 is temporarily moved away in a vertical or z-direction from the advancing donor medial 14 and then lowered prior to restarting the printing process for the next color media, for example, the cyan media section 119 as illustrated in FIG. 2c. The bi-directional universal stepper motor 121, repositions the thermal print head 111 at a pre-selected angle in preparation for the next step of reverse printing (right to left). There is shown in FIG. 2b the step wherein the thermal print head 111 actuates a line of thermal printing elements 112a at the trailing edge 113b and prints the magenta media section 181 sequentially towards the leading edge 113a and onto the thermal output media 113.

Referring to FIG. 2c, the thermal head 111 ends up at the left or leading edge 113a of the output media 113 after the step of printing the magenta media section 181. The next step is the macro process of printing the cyan media section 119 in a leading edge 113a to trailing edge 113b direction (left to right). In FIG. 2e is the step of printing the black media section 120 in a reverse right to left direction. This is similar to the previous description of the step of printing the yellow media section 115 and the magenta media section 181, respectively, as shown and described previously referencing FIGS. 2a and 2b. In the novel sequencing of steps using the preferred printing mechanism 100, the step of ejection of the thermal output media 113 as illustrated FIG. 2f, occurs only after completion of the steps of printing all colors or media sections.

A first temporary ejection (not illustrated) of the thermal output media 113 can electively occur after the first complete pass of the print head 111 from the leading edge 113a to the trailing edge 113b (left to right) for the color yellow 115. Referring now to FIG. 2c, on the next sequence of printing from the trailing edge 113b to leading edge 113a (right to left) another elective second temporary ejection of the thermal output media 113 may occur. In the novel structure and method of the invention, at least three temporary projections are eliminated using bi-directional or bilateral printing. The total printing time T₀ using prior art sequencing is significantly reduced to T_{N} using the novel invention whereby T₀>>T_{N}.

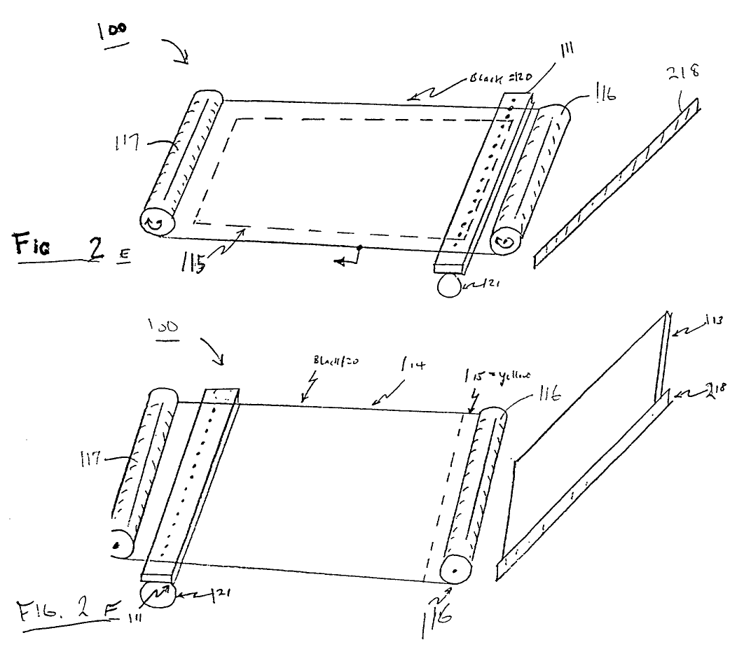

In FIG. 3, there is shown a first alternate or second preferred embodiment wherein a printing mechanism 200 utilizes two separate thermal heads 11a and 11b. Each is connected to a separate but equivalent universal stepping motor 222 adapted to operate bi-directionally. The print mechanism 200 uses a single donor media spool 316 and an uptake spool 317. The alternative embodiment is enabled by using the stepper motor 222 as a unidirectional stepper means to control the movement of both heads 11a and 11b. The heads 11a and 11b have a first heating element set 312a and a second heating element set 312b, respectively. Thus, the first alternative embodiment as shown in FIG. 3 is adapted with the additional steps of sequentially moving thermal output media 313 having a leading edge 313a and a trailing edge 313b in two directions: for example, first in a right to left direction, after which head 11a transfers yellow from a yellow media section 315 of a spooled donor media 314 in a left to right direction starting from the leading edge 313a of the thermal output media 313. After yellow has been completely transferred to the thermal output media 313 as previously described, the thermal output media 313 moves in a left to right direction and wherein after which the thermal output media 313 is positioned such that head 11b transfers magenta color from the magenta media section 318 of the thermal donor media 314. As a further alternative step, the spooled donor media 314 can be mechanically sequenced to move in a right and in a left direction to achieve a reduction in the overall size physical size of the spooled donor media 314 when the two heads 11a and 11b are both utilized to transfer color from the same sections of the spooled donor media 314.

The novel method is completed by repeating the above step as described for the color yellow such that in addition to sequential printing of the colors yellow and magenta, next the color cyan and then the color black is printed using the thermal elements 312a and 312b, respectively. Hence, the color cyan (not shown) is printed like the color yellow 315 and the color black (not shown) is printed like the color magenta 318. Only one output paper ejection step is utilized and required. A substantial time savings of at least 20% is realized due to having only one paper ejection step instead of three as required and utilized by prior art printers.

The novel arrangement of the printing mechanism 200 shown in FIG. 3 provides additional time savings by employing the two separate print heads 11a and 11b and by the repositioning thereof serially with like serially scheduled or programmed printing times. In the novel assembly and operation of the printing mechanism 200 the first thermal print head 11a is repositioned as the second thermal head 11b is printing and vice versa.

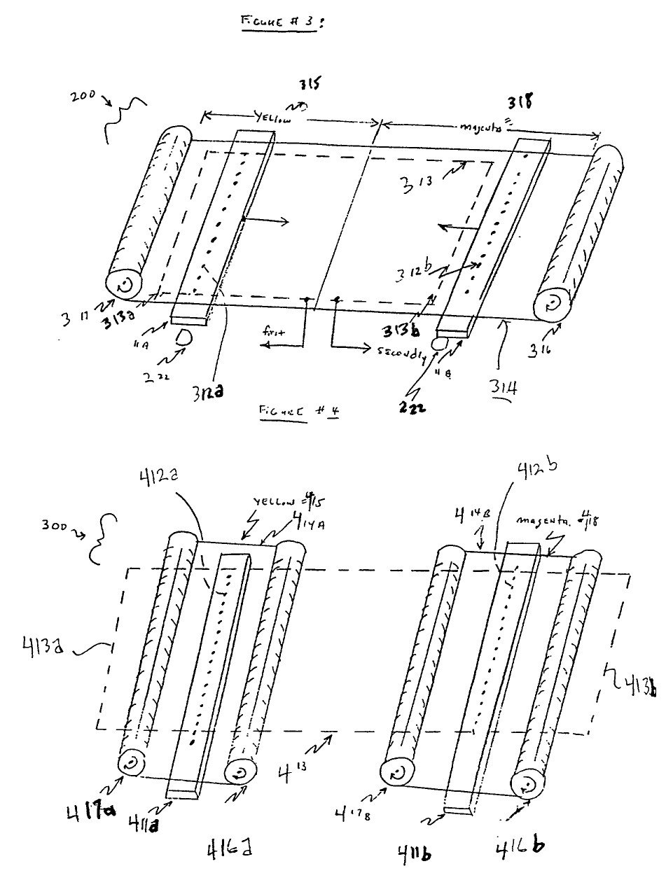

A third alternative preferred embodiment for the novel operating structure is shown in FIG. 4. This novel arrangement for a printing mechanism 300 provides at least two adjacent thermal heads 411a and 411b and at least two sets of related juxtaposed donor media spools 416a, 416b, and 417a, 471b, respectively. The printing mechanism 300 is made up of a combination of first and second thermal heads 411a and 411b and a spooled donor media 414a at the left of the hard copy output media 413 and a spooled donor media 414b at the right of the hard copy output media 413. The donor media 414a is mechanically and fixedly connected in-between a first donor media output spool 416a and a first donor media input spool 417a. The donor medium 414b is mechanically and fixedly connected in-between two roller mechanisms 416b and 417b. In this last described embodiment, it is significant to recognize that the printing mechanism 300 is merely a simple exemplary embodiment. This alternative novel embodiment can be expanded to include more than two sets of donor mediums in a donor mechanism and more than two donor mechanisms with a like increase in printing heads such as 411a and 411b. It should be noted that these two donor mechanisms 416a and 416b may easily number three, four, or more mechanisms or N mechanisms where N is an integer and N≧2. This embodiment results in an overall improvement in printing time due to the parallel feature of printing with two heads which result in less additive donor spooling time, less additive time to move the thermal head in the z direction and the ability to print 1.5 colors for each complete pass of one of the two thermal heads.

In yet another alternate structure or fourth embodiment, the printing mechanism 300 is as shown in FIG. 4 and described above. With the two printing thermal heads 411a and 411b and two spools 416a and 416b of donor media, respectively, at least two colors can be simultaneously printed with simultaneously activated print heads. The novel invention is adapted to accomplish this operational level by employing known stepper motor control technology to simultaneously operate thermal heads 411a and 411b and/or, alternatively a stepper motor control for the two spools 416a and 416b of donor media. Basically, one head 411a thermally prints all pixels within a row 412a at the leading edge of the paper 413a. The other or second head 411b thermally prints all pixels within a row 412b at the trailing edge 413B of the thermal output media 413.

In yet a second alternate structure to the 4^{th} embodiment, a mechanical arrangement the thermal heads 411a and 411b are controlled by a stepper motor (not shown), then thermal head 411b is located 1/2 the distance of the donor medium 414a which is mechanically and fixedly connected in-between the two roller mechanisms, for example spools 416a and 417a, and is adapted to move in the direction of the printing process. The thermal printing head 411a is positioned at the leading edge 413a of the thermal output media 413. Both heads 411a and 411b travel during the same time interval in unison in a reverse direction with the head 411b beginning at the trailing edge 413b of the thermal output media 413. The head 411a thermally prints 1/2 or midway across the thermal output media 413 while the 411b thermally prints 1/2 or midway across the thermal output media 413 in a sequencing of steps for operation of the printing mechanism 300. As thermal head 411a completes 100% of its' printing process, thermal head 411b will have printed 50% of its' printing process and so on. Therefore, a printing time efficiency equal to or greater than 50% per two thermal colors is achieved since the print head 411a completes 50% of its operational task during the same time interval the head 411b is operational.

In FIG. 4, two spools of thermal donor media 414a and 414b are depicted wherein spool 414A is shown to contain yellow media 415 and cyan media 419. The donor media 414b is shown to contain magenta media 418 and black media 420. All media described are thermally activated to print.

The two donor media 414a and 414b can be increased by one of ordinary skill to four sets of donor media with one of each of four heads adjacent and underneath each set of donor media wherein, for example, spool 414a is 100% yellow media; spool 414b is 100% magenta media; and by linear extrapolation a spool 414c (not shown) is 100% cyan media and interposed between the spools 414a and 414b; and 414c (not shown) is 100% black media and also interposed between the spools 414a and 414b. The operation of this arrangement results in a time savings of approximately 63% for the entire printing process with an additional increase in efficiency associated with the time savings for head mechanical alignment and positioning of the multiples heads simultaneously and the time savings associated with multiple thermal output media projection times, thus significantly reducing total printing time.

As thermal heads have become cheaper and smaller and are now more widely used in consumer applications, the third embodiment is economically viable for large scale production. It should be noted that it is well known to those in this art that with certain known types of thermal output media, the density of printing elements or pixels is increased, sometimes by a factor of 2 to print four separate pixels in an equivalent 300 dpi density due to the color science of printing one color before another and vice versa in different areas of the same output media.

The invention has been described in detail with particular reference to a first preferred embodiment thereof, but it will be understood that variations and modifications can be effected within the spirit and scope of the novel invention and subject to the doctrine of equivalents.

### PARTS LIST

10 prior art printer mechanism

11 thermal print head

11a first thermal print head

11b second thermal print head

12 thermal heating elements

13 hard copy output

13a leading edge of hard copy output

13b trailing edge of hard copy output

14 donor material

15 yellow donor media

16 first donor media spool

17 second donor media spool

18 donor media magenta

100 first thermal printing mechanism

111 thermal print head

112 heating elements

113 thermally sensitive output media

113a leading edge of thermally sensitive output media

113b trailing edge of thermally sensitive output media

114 donor media

115 yellow media section

116 first donor media spool

117 second donor media spool

118 customer retrieval shelf

119 cyan media section

120 black media section

121 universal stepping motor

181 magenta media section

200 first alternate printing mechanism

218 customer retrieval shelf

222 universal stepping motor

312a first heating element set

312b second heating element set

313 thermal output media

313a leading edge of thermal output media

313b trailing edge of thermal output media

314 spooled donor media

315 yellow media section

316 single donor media spool

317 uptake media spool

318 thermally sensitive donor media with magenta

color donor area

319 thermally sensitive donor media with cyan color donor area

320 thermally sensitive donor media with black color donor area

300 alternate third thermal printing mechanism

411a first thermal print head

411b second thermal print head

412a heating elements of thermal head 411a

412b heating elements of thermal head 411b

413 thermally sensitive hard copy output media

413a leading edge

413b trailing edge

414a spooled donor media

414b spooled donor media

415 thermally sensitive donor media with yellow color donor area

416 first donor media spool

417 second donor media spool

416a first donor media output spool

416b second donor media output spool

417a first donor media input spool

417b second donor media input spool

418 thermally sensitive donor media with magenta color donor area

419 thermally sensitive donor media with cyan color donor area

420 thermally sensitive donor media black color donor area

What is claimed is:

1. A thermal printer adapted to produce at least one output sheet of a material with color printing thereon, comprising a donor material and a single printing head having a first means for transferring said donor material to the sheet; said donor material comprising at least a first substance having a first distinct color and a second substance having a second distinct color; the output sheet of the material being transferred during two linear directional movements of said printing head whereby as a result of said two linear directional movements of said printing head, said printing head transfers at least said first substance and said second substance to the output sheet and whereby a printing of an image appears on the output sheet.

2. A thermal printer adapted to produce at least one output sheet of a material with color printing thereon comprising donor material and at least a pair of printing heads, each print head having a first means for transferring said donor material to the output sheet; said donor material comprising at least a first substance having a first distinct color and a second substance having a second distinct color; the output sheet of the material being transferred during two linear directional movements of each said printing head, whereby there are two linear directional movements of each of said printing heads, each of said printing heads transferring at least said first substance and said second substance to the output sheet whereby a printing of an image appears on the output sheet.

3. A thermal printer adapted to produce at least one flexible output sheet of a material with color printing thereon by printing a plurality of rows comprising a first donor material from a first packet and a second donor material from a second packet and at least first and second printing heads, the first print head having a first means for transferring said first donor material to the flexible output sheet, the second print head having a second means for transferring said second donor material to the flexible sheet, each of said donor material packets comprising at least a first substance having a first distinct color and a second substance having a second distinct color; the output sheet of the material being transferred during two linear directional movements of each of said printing heads, wherein the first and second printing heads are adapted for printing alternate rows of said rows, said first printing head printing a first row and said second printing head printing a second row whereby there are two linear directional movements of each of said printing heads, each of said printing heads transferring at least said first substance and said second substance to the output sheet whereby a printing of an image appears on the output sheet and wherein the output sheet is ejected from said printer.

4. A thermal printer adapted to produce at least one flexible output sheet of a material with printing thereon by printing a plurality of rows comprising at least first and second printing heads, the first print head having a first means for transferring a part of a donor material to the flexible output sheet, the second print head having a second means for transferring another part of said donor material to the flexible output sheet; the output sheet of the material being transferred during two linear directional movements of each of said printing heads, wherein the first and second printing heads are adapted for printing alternate rows of said rows, said first printing head printing a first row and said second printing head printing a second row whereby as a result of the two linear directional movements of each of said printing heads, each of said printing heads transfers part of the donor material to said output sheet, said printer further comprising said first and second printing heads, mechanically positioned parallel to each other, the output sheet having a lead edge and a trailing edge, said first printing head being mechanically positioned to print on the leading edge and said second thermal printing head being mechanically positioned to print on the trailing edge, the first and second printing heads using a single mutually accessible contiguous spool of said donor material whereby a printing of an image appears on said output sheet and said output sheet is ejected from said printer.

5. A thermal printer according to claim 4 wherein said output sheet has a distance from the leading edge to the trailing edge and said second printing head is further mechanically adapted and positioned to print at one half of said distance from the leading edge to trailing edge.

6. A thermal printer adapted to produce at least one flexible output sheet of a material with printing thereon by printing a plurality of rows comprising at least first and second printing heads, the first printing head having a first means for transferring a part of a donor material to the output sheet, the second print head having a second means for transferring another part of said donor material to the output sheet; the output sheet of the material being transferred during two linear directional movements of each of said printing heads, wherein the first and second printing heads are adapted for printing alternate rows of said rows, said first printing head printing a first row and said second printing head printing a second row, each of said printing heads transferring part of the donor material to said output sheet, said printer further comprising said first and second printing heads mechanically positioned parallel to each other, the output sheet having a lead edge and a trailing edge, said first printing head being mechanically positioned to print on the output sheet and on the leading edge thereof and said second thermal printing head being mechanically positioned to print on the output sheet and on the trailing edge thereof, the first and second thermal printing heads each using a separate pair of exclusively accessible contiguous spools of said donor material whereby a printing of an image appears on the output sheet wherein the first thermal printing head is mechanically adapted to print at the leading edge of the output sheet and the second thermal printing head is mechanically adapted to print at the trailing edge of the output sheet, whereby said two linear directional movements of each of said printing heads prints an image on the output sheet and the sheet is ejected from said printer.

7. The thermal printer according to claim 6 wherein each head has at least two spools of contiguous donor material and wherein each spool contains donor material comprising at least two thermally transferable colors.

8. The thermal printer according to claim 7 wherein each head has at least two spools of contiguous donor material and wherein each spool contains a singular thermally transferable color.

9. A method of operating a thermal printer adapted to produce at least one output sheet of a material with printing thereon comprising the steps of: (a) printing a plurality of rows using a first printing head and a second printing head, (b) transferring a part of a donor material to the output sheet from the first print head; (c) transferring another part of said donor material to the output sheet from the second print head; (d) transferring the output sheet of the material during two linear directional movements of each said printing head; and (e) printing alternate rows of said rows alternately using said first printing head and said second printing head whereby a printing of an image appears on the output sheet and the sheet is ejected from said printer.
